(19) United States
(12) Patent Application Publication
(10) Pub. No.: US 2002/0023771 A1
(43) Pub. Date: Feb. 28, 2002

(54) Problem solver connectors

(76) Inventor: Richard L. Gerencir, Joliet, IL (US)

Correspondence Address: Richard L. Gerencir, 1301 AGNES AVE., Joliet, IL, 60435, US

(21) Appl. No.: 09/736,706

(22) Filed: Dec. 15, 2000

Related U.S. Application Data
(60) Provisional application No. 60/172,661, filed on Dec. 20, 1999.

(51) Int. Cl. H01R 4/00

(52) U.S. Cl. 174/88 R

(57) ABSTRACT

An electrical device invented for creating multiple AC/DC wire repairs and connections on any electrical circuit using small gauge electrical wire. The conductor of the connectors is to be of any ductile metal of choice. As with the insulator is to be of any material which can be used in the process of heat formed injection molding and said material must be able to be colored: red, blue, and yellow to keep with the standard color code of wire identification in the electrical industry. These connectors are to accommodate the wire gauge sizes of #22, smallest to #12, largest. PSC are engineered to for applications of use that include: repairing two and three wires in one connector, with different electrical polarities; Splicing of one wire into the connector and have two or three separate leads of the same polarity on the opposite side of the connector; connectors with connection leads at a right angle to connector for space utilization; either of these connectors will facilitate a quality connection of repair or utilization of electrical wiring in application of choice with out special tooling or methods.

### BACKGROUND

1. Field of Invention

This patent application is in reference to P.P.A. number 60/172,661; which was filled Dec. 20, 1999 with the Patent and Trademark Office. The technical background of Problem Solver Connectors, or PSC is derived from the mechanical field of repair. Primarily towards the repair technician, professional or amateur. In either instance, its fundamental use is easily comprehended by anyone who needs to repair damaged wiring, or create unique electrical circuits for a specific application of technology. This field of repair consists of any machinery that has incorporated as part of its design, AC or DC electrical circuits which consist of small gauge electrical wire to perform connection and transfer of electricity to any electrical component, source or load. By source or load, in its proper meaning, being any component of an electrical circuit that either provides electricity/source, or uses the electricity to perform an engineered task/load. Some specific examples of machinery that PSC would be used in are as follows: automobiles, light duty trucks, diesel powered trucks, farm equipment, forklifts, propane powered equipment, motorcycles, and directional boring equipment.

2. Description of Prior Art

The basis of Problem Solver Connectors is its unlimited application in repairing electrical wiring. The prior art cited as reference, as obtained through a patent search, definitively describes its limitations in uses due to design of application. As I will show in detailed comparisons of each of the following related cases:

a. U.S. Pat. No. 2,173,668 (Smith)

b. U.S. Pat. No. 3,656,092 (Swengel et al)

c. U.S. Pat. No. 3,675,188 (Startin et al)

d. U.S. Pat. No. 3,708,611 (Dinger)

e. U.S. Pat. No. 5,118,313 (Delalle)

To begin, while Smith's electric wire connecting device is for connecting a single wire in series; Problem Solver Connectors are for repairing multiple wires at one time. In addition, Smith claims to have certain advantage of a “positive” grip. This is without a doubt, no way near the advantage of any PSC invention. I base this statement off actual experience of using connectors just like his in my field of profession as a mechanical technician. The idea of PSC came to be after using various types and designs of connectors. Each one has had the same thing in common which makes PSC that unique and useful. As in all my figures of drawings, ease of gripping, and the aspect of multiple wire usage is evident. At the same time my drawings also show limitless possibilities of application due to the configuration of the staggered conductive metal leads (FIGS. 2-5 of drawings). Also, one key item of Smith's connector from PSC is the usage of tubed conductors. This is greatly contrasting to mine in that I designed my conductive metal leads to be manufactured flat and then the ends to be rolled; which then creates the area of crimp for insertion of wire (FIGS. 1-5,item1). In FIGS. 1 through 5, each drawing states the unique invention of adaptability of PSC to countless applications of AC and DC electrical wiring as used in technology to date; by allowing the option to creatively repair fatigued, damaged, and customized wiring problems.

In case of U.S. Pat. No. 3,656,092, Swengel×terminal device for welded termination of electrical leads; this case is of great difference of Problem Solver Connectors for very specific reasons. To begin, look at relative use of such device, it clearly does not do the same function of repair or method of repair. Its function is to weld together wire and connector for purpose of peradventures affixing a connector that is to be temporarily connected. This is the equivalent of a plug on a lamp in your home. It was designed for more of a manufacturing aspect, not repair motivated. Problem Solver Connectors are designed for repairing damaged wiring, and creating new types of circuit configurations in application of need. For instance of wiring an extra break light into the rear of a boat trailer. PSC would be used to peradventures secure the circuit, and at the same time provide an added metal lead in which to tap into an existing power source by “splicing” into a power supply wire going to another break light in the rear of the trailer. Also, this design by Swingle incorporates tubing as main body of connector, as did Smith with his connector, and both ideas focus on one wire connectors, not multiple wires. The focus of PSC is the use of multiple wire use at one time of repair with one connector! More time efficient than trying to engineer another separate wiring circuit for just one break light.

The case of U.S. Pat. No. 3,675,188, Startin—multiple cold crimp sleeve plug and socket; this connector while its design consists of multiple wire connections with insulated material, its differences are apparent. The manufacturing process is the greatest difference. This process consists of round tubing inserted in to an insulated body and then being crimped by a machine by means of an extrusion process. What this means, this process of manufacturing is intended to have wire already installed into the said connector at time of cold crimping. In this application, the actual action of crimping is in no way intended to be performed at the site of repair. Which in many situations this process can not be done in enclosed areas such as under a dashboard of a vehicle. Now no actual size is given of such a “machine”. Also there is only assumption of this statement, and no mention of any other tool is made mention of for performing the crimping process in an area in very close proximity of a repair. This would require the patent of this case to disclose a closer relation of said connector with the invention of Problem Solver Connectors' steps of usage in application. In regards of said connector it is also described as being used along with another piece or connector to be inserted into said connector; meaning that this is a more temporary situation and consisting of more than one object for completion of connection.

The process of Problem Solver Connectors is different from said connector of the previous paragraph; by which the manufacturing process and applications are of separate entities. To begin, the process of making PSC is first done by either die stamping, or laser cutting of ductile metal leads in a certain pattern. Then a die-rolling process of the ends of the metal leads, which are to be used for the crimping at time of repair. Thirdly heat injection molding of dielectric material around said metal lead, and the insertion of rubberized heat shrinkable tubing over exposed crimp ends.

In terms of application, PSC are a great advantage when efficiency steps in. First, to install PSC, only one connector is needed to repair the circuit, or splice into. Secondly, no special “machine” is needed to crimp the wire into place; only the use of hand pliers, needle nose pliers (for a tight space of working), or a standard crimping hand tool is needed. Also, These tools are readily available to any professional technician and layman needed to use a Problem Solver Connector.

Next case of discussion, U.S. Pat. No. 3,708,611, Dinger×heat shrinkable preinsulated electrical connector. Where again shown, this connector is specific to connecting one wire per connector. Another aspect of this connector is the use of a metal barrel or tube as part of its main body of function. As I have described in earlier descriptions this is a concept different in main focus of application in comparison to Problem Solver Connectors. Where the invention of multiple wire repairing with one connector is evident. In addition, PSC uses flat stamped conductive metal leads enclosed by a main body of dielectric insulating material, that is not heated as part of installation of the connector onto the wire of repair. Also in FIG. 8 of Dinger's case, he shows inserting two wires into his connector and then attempting to crimp and secure them in place. This fault of parallel insertion into one body results in poor security of wire in connection by over stuffing the connector and reliability placed on the person using the connector, that the crimp was done to a compression level adequate to securely hold both wires. Actually having used connectors of this type, applying multiple wires into one end of the connector, the time and connectors that are discarded in attempting to perform such a repair are not cost effective in time used or waste of connectors. In short, the right tool for the job.

Lastly, U.S. Pat. No. 5,118,313, Delalle—electrical terminal. This case discloses a terminal that can be repeatedly disconnected. This is of great difference to PSC in that the focus of the invention is on the point if disconnecting and reconnecting the terminal, not the wire. This use of a terminal is for plugging into or disconnecting when needed; like plugging in the toaster in my kitchen. In the application of PSC, one of the invention's focuses is on the permanent repair of multiple wires at one time. These two inventions are clearly intended for different uses of application, no comparison is needed, for the difference is fundamentally different.

Objects and Advantages—Problem Solver Connectors

To communicate throughly the invention of Problem Solver Connectors (PSC), this section of the application will focus on the solid objects and advantages of this invention. As described in some detail earlier, PSC has very unique and specific characteristics to be considered:

(a) to provide multiple, side by side wire repairs to be done with one connector, that eliminates multiple connectors and increases time efficiency of repair;

(b) to provide a longer connector length for easier handling of connector while making repair of wire;

(c) to provide the ability to splice together multiple wires, side by side, of like polarity (positive or negative) in a single connector;

(d) to provide replacement of an obsolete connector in a neater and more permanent form of design;

(e) to provide easy to identify connectors, by color coding each connector in conjunction to wire gauge;

(f) to provide the ability to engineer custom wiring circuits with a connector that is uniform in design for eccentric applications;

(g) to provide a design of connectors that are modular for increasing application of uses;

(h) to provide connectors that can secure wires without using special tools or processes. Further objects and advantages of Problem Solver Connectors are, that laymen as well as professionals will be able to efficiently utilize these connectors with limitless possibilities. In addition, the applications of use for these connectors are countless and superior by comparison to current marked connectors for reasons that, PSC will be successful in any application of smaller gauge electrical wiring and repair, AC or DC, that exists currently.

### SUMMARY

In accordance with present invention an electrical device for joining separated AC/DC electrical wiring, with multiple wire connections in a single connector, with various configurations of said connector in wire gauge and in number of wires used per connecting device for repair.

### DRAWING FIGURES OF PROBLEM SOLVER CONNECTORS

FIG. 1: This drawing of perspective view of a PSC multi-wire connector and other objects related to the use of invention, shows in detail the construction of this PSC in its specific focus of application; which is a multi wire connector specifically invented for use with repairing damaged wires at location shown in detail and useful in similar applications of restriction.

FIG. 2: Shows a perspective view of a PSC in application of it's focus of use. In which construction of the two wire configuration connector is shown in detail in a general application of designed use.

FIG. 3: This is another broader view of FIG. 2, in that it also is a perspective view of its general application of use of a three wire connector, with specific focus on relationship of configuration of construction to FIGS. 1 and 2;

FIG. 4a: This drawing shows a variation of the construction of the previous PSC, and also shows the unique scope of the invention in its utility of use.

FIG. 4b: This figure is a schematic diagram of said PSC from FIG. 4a,using symbols for lights, battery, motors, and PSC configuration FIG. 4a, to show general utility of configuration;

FIG. 5a: Another perspective view of detailed construction and scope of the invention's focus in being adaptable to application by construction utilization of PSC;

FIG. 5b: This figure, like FIG. 4b, is to show usage if application in a electrical schematic using symbols for ground side of a circuit, lights, and PSC configuration.

### REFERENCE NUMERALS IN DRAWINGS

1.Alignment holes

2.Conductive ductile metal leads

3.Dielectric insulating material

4.Rubberized heat shrinkable protection

5.Rolled crimp ends

6.Wire

7.Fuel injector connector

8.Intake manifold

9.Fuel injector

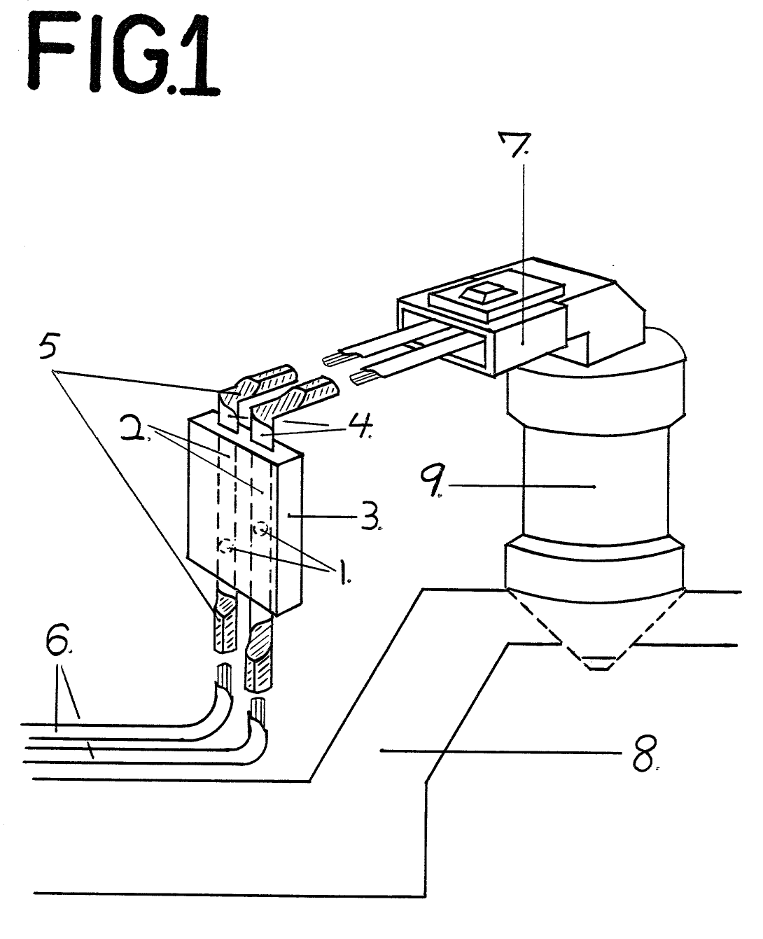

Description—FIGS. 1 to 5

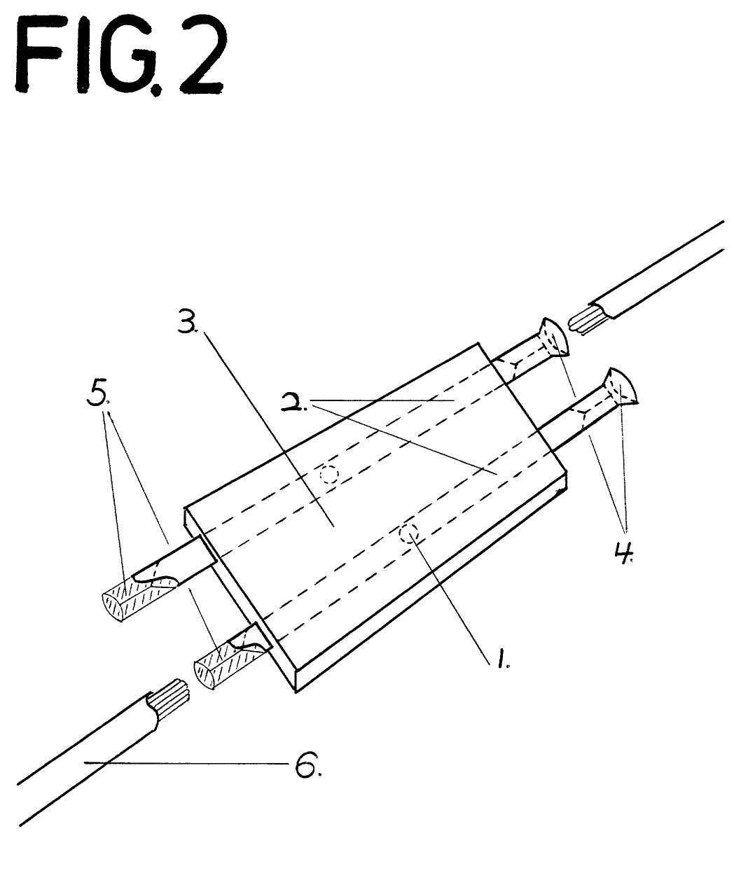

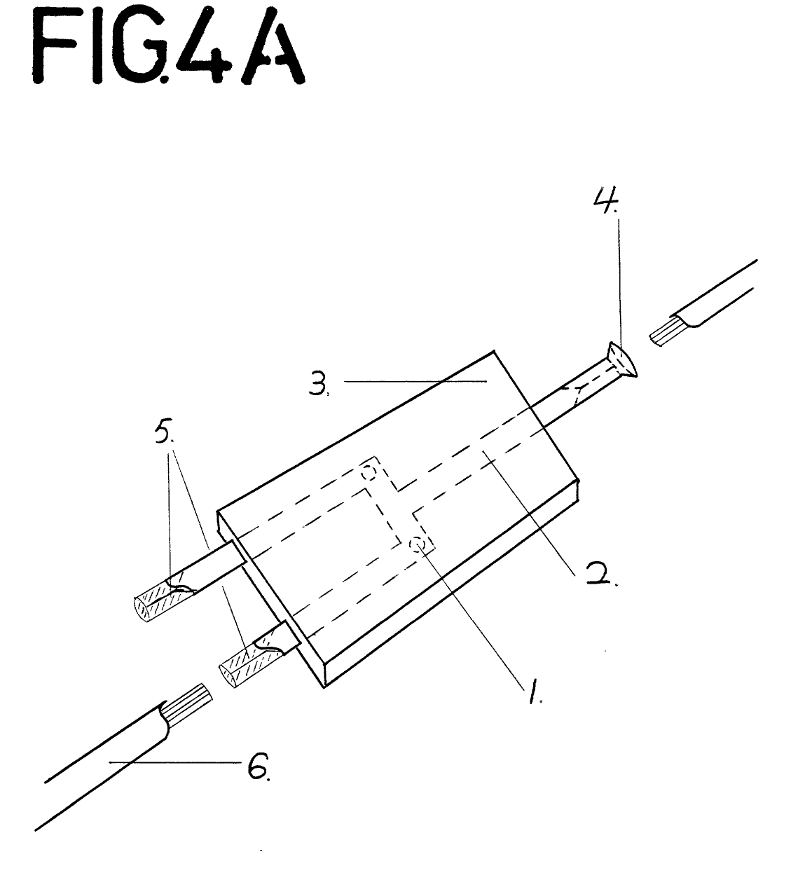

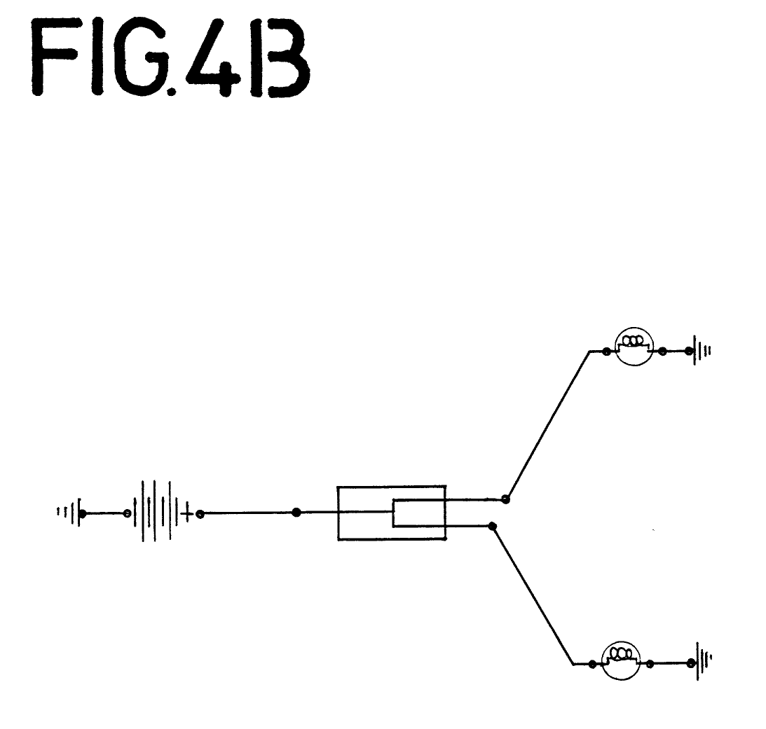

The embodiment of the present invention is illustrated in FIGS. 1-5 (perspective view). To begin, the main construction of each of the Problem Solver Connectors is the same. The metal conductor of electricity can be of any ductile metal that conducts electrical current (FIG. 2 and FIG. 4—item2). The process to form each connector consists of the same processes, even though the configuration of each of the designs are different; this is to keep costs low, and provide a series of connectors which can cover a broad scope of applications and uses. The thickness of the ductile conductive crimping ends (FIGS. 1 to 5a—item5) are key when considered the aspect of which tool is needed to crimp the end in application. Too thick and it will not be able to be crimped with needle nose pliers and a extreme amount of force will be needed to crimp the end with any tool: to thin, and the integrity of its construction if compromised, and the connector is a failure. This part of the engineering of the connector will be vital when manufacturing begins. In addition to the special rolled crimping ends, the overall length of the connector is going to be a major asset to this invention. The overall length of PSC will be that of about 2 inches; which compared to any other connector of prior art, is three to four times longer! This point of detail will increase handling of PSC when in field of repair and reduce the need for over-tensioning of a wire that had to be slightly shortened for need of removing damage before crimping on the repair connector. This aspect of PSC operation will be covered in the operation section following.

The start of the manufacturing process begin with the machine stamping of the main body of the conductive portion of the connector; in which machined dies will have to be made of each configuration of PSC. In this part of the construction of the connector, an alignment hole (FIGS. 1 to 5—item1), will be made for the next phase of manufacturing. This alignment hole is for the securing of the insulative material around the ductile conductive metal in the next phase. This process can become costly, due to number of configurations needed; so a second process, which can be used in place of the first, would be computerized laser cutting. This would consist of entering data into and programing a laser cutting machine to manufacture the conductive portions of the connector. This process is a great alternative to conventional machining processes, though not yet common in the aspect of manufacturing of electrical connectors. This process of laser cutting may seem to be more expensive, it actually is more efficient and cheaper. The time and cost used to make one stamping die would almost pay for laser cutting all designs of P.C. to be manufactured. When manufacturing the PSC of FIGS. 2 thru 5a; the ductile conductive metal leads (item2), will be engineered in a staggered position to give easy access for securing multiple wires to a single connector. Thirdly, the rolled crimping ends are to be created, (FIGS. 1to 5—item 5). This process of die rolling, will consist of rolling all of the metal individual leads to create the area that will be used to crimp or solder the wire to be repaired to. This phase of creating any of the PSC can be used for most any metal available, with detail to cost and quality to be considered. Which allows PSC not to be of one limited metal, but the luxury to be versatile in application, dependent on requirements at time of manufacturing. The next phase of the manufacturing process of each of the P.C. would be the installation of the insulative material around the conductive metal, (FIGS. 1 to 5—item4). This dielectric insulating material should have these necessary characteristics; able to withstand the process of heat forming injection, able to be of color necessary to designate application of wire it will be used on, and not damage the integrable construction of the unit. The dielectric insulating material that is used in this process is engineered for withstanding electrical circuit damage of heat, current, and voltage fatigue. This process will consist of creating two piece dies that the precut ductile metal conductors, described earlier, will sit inside of. Then these dies will go threw the process of plastic injection molding, whereafter the dies will be separated and the last step of manufacturing the P.C. will take place. The installation of heat shrinkable rubberized tubing at each of the rolled crimping ends of the connector, (FIGS. 2 to 5—item4).

This aspect of manufacturing is simply to protect the exposed ductile metal leads that are not encased in the dielectric insulating material; in addition to sealing the new wire connection made at time of connector installation. Where by heat will be applied to secure corrosion of connection from forming. In all configurations of said invention, this described manufacturing process will be used to create all PSC; as for application of each configuration of this invention, that varies greatly.

To begin, FIG. 1 shows a perspective view of a multi wire connector with a right angle bend engineered into its construction. This idea is to accommodate for applications in which utilization of space and available wire for repair are necessary requirements to make a quality repair. As drawn in FIG. 1, the repair is on two wires that power an electric fuel injector (FIG. 1 item9) on an automobile. Customarily, when these specific wires break due to heating of the engine (FIG. 1—item6); there is little wire left at the site of repair to make a quality repair. In addition to that fact, the connector (FIG. 1—item7) at the injector is not readily available to technicians or amateurs at time of need. To repair this wire efficiently, time and cost aspects, I engineered this Problem Solver Connector to successfully repair wiring of this sort and application. In part to this connectors success is that no special tools are required to crimp or secure the wire to the connector; where the prior art connectors all require a special crimping toll, which requires ample room to hold the connector in place to securely repair the wire. In this type of repair described, that luxury of space is not available due to the nature of the repair. PSC needs only a pair of needle nose pliers to secure the wire in the connector with very little space of operating the tool for repair. This aspect of P.C. makes it superior in construction and function in field of application; where by it is taken in consideration that space cannot be taken for granted when attempting to repair damaged wiring in field applications.

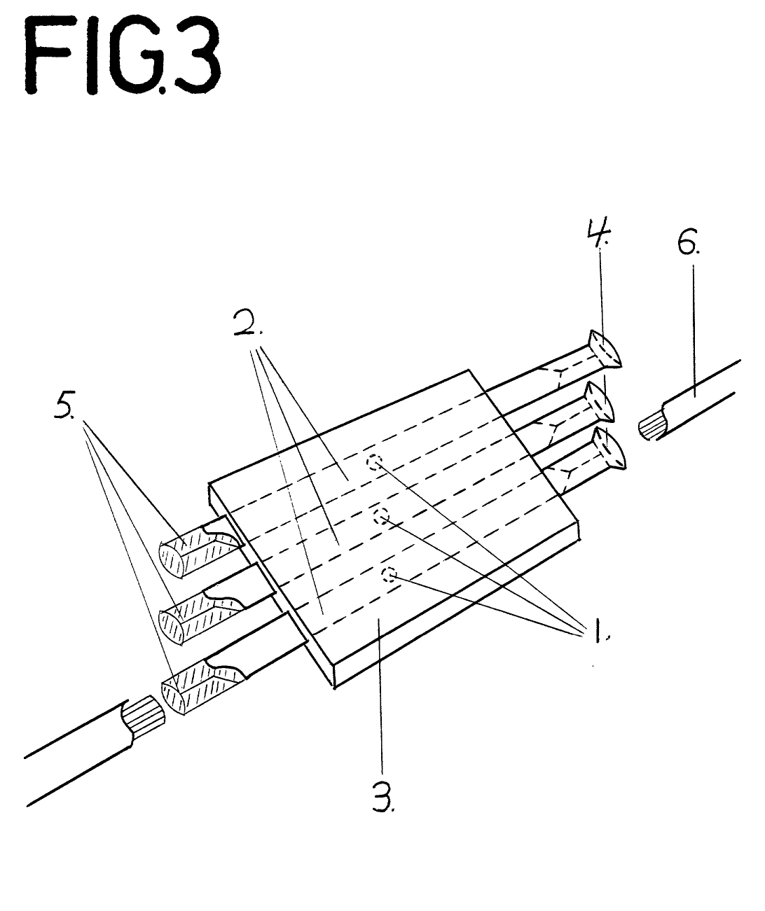

In FIG. 2 as well as FIG. 3, the scope of these connectors' configurations are focused on repairing multiple wires with one connector. This is done by securing two, (FIG. 2) or three (FIG. 3) separate ductile metal conductors (item2) in the same dielectric insulative cast, (Item3), then stager the alignment of the conductors. This in turn creates a configuration that allows two and/or three wires to be repaired with one PSC; which in the field of invention and application, this example is very common for technicians to have to successfully repair. By keeping the ductile metal conductors (item2), separated this allows for having two and/or three wires being repaired that are for separate electrical circuits, ie: ground circuit wire, input sensor wire to a vehicle computer, or power supply for throttle position sensor. This configuration also is great in repairs of existing two piece weather pack OEM connectors that become corroded or have poor connections due to wear by vibration, like in a farm tractor that sees lots of off-road use. With this type of poor connection, it creates inadequate electrical connections that cause periods of loss power to a component, or a loss of ground, either of which can damage electrical components. PSC FIGS. 2 and 3, are a great way to replace OEM parts in this application with a more reliable replacement part by using one connector that will neatly and securely hold up to this application of use. Where prior art examples aren't designed to do what Problem Solver Connectors can do.

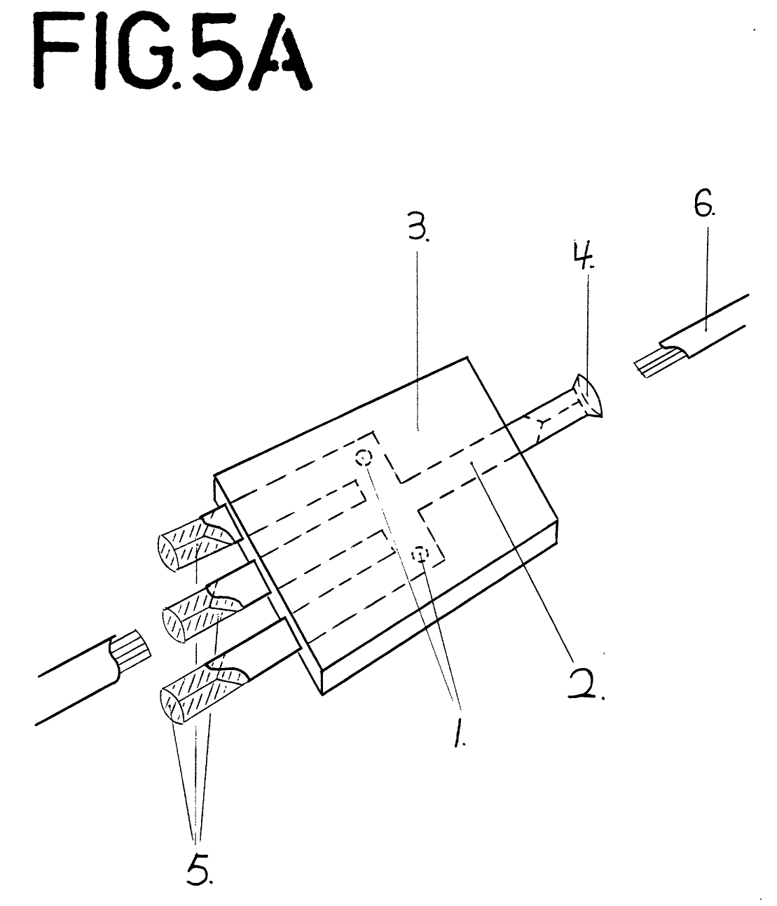

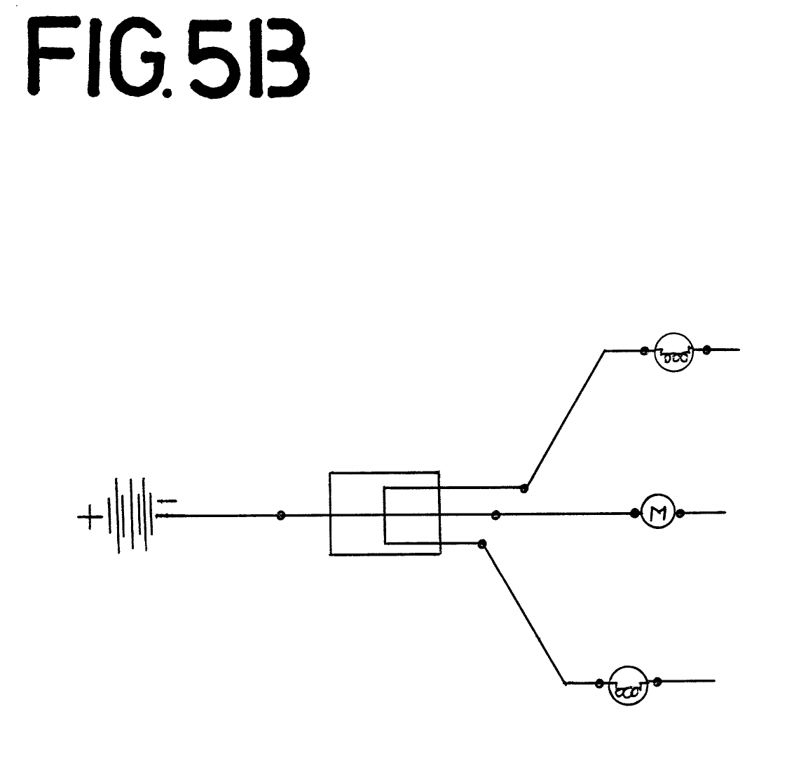

Now to FIGS. 4a. and 5a, the application of these PSC are extremely unique and versatile. As you can see in FIGS. 4a. and 5a, its scope of invention is splicing one wire into two or three separated electrical circuits. Starting with FIG. 4b, this is an electrical schematic that shows the theory of a true PSC splice connector; where as a single power wire can be made to supply two different loads of electricity. Such as on a forklift, where a technician is adding into the electrical system two new lights for low light application; a single power wire from the battery can have a PSC splice connector installed onto it, which then allows for two power wires to be utilized from the original single wire to supply power to the added work lights. The same is true for the ground side of an electrical circuit. In stead suppling power, ground is needed for the same two work lights. In FIG. 4c, the electrical schematic shows two separate grounding wires adjoined to the same configuration connector at one end, with a single wire on the other that goes directly to the negative side of the battery. Same purpose as in the previous example, just current is flowing the opposite way thru the second connector. Splicing wiring is a task that most any person that has to custom design an added electrical circuit has to be able, at one time of another, splice wires with quality and efficiency. Prior art has demonstrated that such possibilities of repair, are something that is not attainable with any other patented connector seen to date. As seen in FIGS. 4a,c ,and c, FIG. 5a,b, and c's scope is the exact same as FIG. 4, except the PSC splice results in three wires on the opposite side of the connector! This is simply done by changing the configuration of the ductile metal conductor. With the invention of these uniquely different configurations of connectors, there has been created a whole new way of quality and of efficiently repairing and customizing new and old electrical wiring applications in the field of use. The applications that Problem Solver Connector inventions have created and that they can currently be used is of significant purpose to the scope and claim of this patent application.

Operation—FIGS. 1 thru 5a

The manner of using Problem Solver Connectors to repair damaged wiring or create a new circuit, is identical in the operation of securing a wire to any existing connector; except for the point of which tool to use. In the case of Problem Solver Connectors, the tool of choice is going to be the one that gets the job done quickly and with quality; in addition to being able to utilize a tool and connector in a confined space of repair. For most other connectors existing, a pair of “wire terminal crimpers”, are what technicians and laymen use. This tool is acceptable when plenty of space to do the repair is available. However, in the application that was described in FIG. 1 of the Description section, this crimping tool will not be able to be used due to space restrictions. With PSC, needle nose pliers can be used to crimp in that described application; this is due to the main construction of the PSC's design of the rolled crimping ends, (FIG. 2), which was also described earlier in the Description section of the application.

Instalation of a PSC consists of the following operational steps. First the exposing of both ends of electrical wire that are to be joined (FIG. 1—item6). Once both ends are prepaired for crimping or soldering to the PSC; meaning bare conductive wire is exposed for securing metal ductile crimp ends. Insert one end of the exposed wire into the rolled crimp end of the connector needed, (FIG. 2—item5); making sure that all of wire strands are in side of the rolled crimp end to ensure good electrical connection. Using a pair of pliers, needle nose pliers, special crimping tool, or device used for compressing; secure the wire in to the rolled crimping end by squeezing the “tool” compressing the rolled crimping end around the wire. Give a little tug to the new connection to ensure the wire and connector are secured adequately. Following the securing of the wire; heat preinstalled heat shrinkable rubberized tubing (FIG. 3—item4) so it will seal the new connection and complete the repair of this end of the connector into the electrical circuit. To finish the repair of connection; repeat these steps of operation on each of the PSC ends that are to have a wire secured them. This operation of the Problem Solver Connector is then complete and can be used in each of the PSC configurations described in this patent application.

Conclusion, Ramifications, and Scope

Accordingly, the reader will see that the invention of Problem Solver Connectors can be used for efficient repair or replacement of small gauge electrical wiring in AC/DC electrical circuits, with the scope and purpose to do said repair and replacement of existing connectors with multiple wires and configurations. This broad scope of applications emphasizes the invention as being new and innovative when in comparison to the prior art at hand.

To specifically point out each configuration of PSC; FIG. 1, a two wire connector for repair/replace operation, with a right angle engineered into its design to create a solution to problems of space and function requirements. FIGS. 2 and 3, used for the purposes of replacing existing OEM two and three wire connectors, as well as the repair of either two or three wires of separate circuits with one efficient connector. FIGS. 4a and 5a, the operation of splicing one wire of designated polarity to either two or three individual terminal leads to secure wiring for separate power supply circuits; or multiple grounding circuits to a single point of ground. All of each configurations theoretically have created solutions to multi-wire repair, replacement, and applications of task left up to the technician or laymen to utilize with efficiency.

Although the description above contains many specificities, these should not be construed as limiting the scope of the invention but as merely providing illustrations of some of the presently preferred embodiments of this invention. For purpose of creation, the configurations described in this application can be engineered for electrical wiring applications larger than those specified here; this advantage allows for a greater scope of applications as applied to this field of invention. Thus the result could conclude to more configurations than incorporated in this application.

Finally, the scope of the invention should be determined by the appended claims and their legal equivalents that exist to support the examples stated.

The claims I would like to be known about PSC will be written on this separate page, as not to create any confusion as to specifically what is being claimed. In addition, the claims recorded here are varied slightly from those that were written for my provisional application, (#60/172,661) due to changes made in the attempt to manufacture PSC prototypes. Though I was working with manufacturing companies to create a prototype, the project is not yet completed due to time frame of filing this patent application. claims:

1. Electrical devices for joining separated AC/DC, small gauged electrical wiring, comprising of:
(a) multiple circuit wires to be joined in an affixed device with the capabilities of opposite polarities of electricity to be repaired in the same connector without use of any specific securing tool,
(b) said device can be comprised of most any ductile conductive metal without changing manufacturing processes,
(c) insulation properties of said device require that such insulation be acceptable to manufacturing processes of heat formed injection molding around said conductor.

2. An electrical device for manipulation of single or multiple distribution of electrical flow of current in a single device for joining separated AC/DC small gauged electrical wiring comprising of:
(a) multiple electrical wires to be affixed to a single device without use of any specific securing tool,
(b) said device can be comprised of mast any ductile conductive metal without changing the manufacturing processes, and
(c) insulation properties of said device require that such insulation be acceptable to manufacturing processes of heat form injection molding around said conductor.
